(19) United States
(12) Patent Application Publication
(10) Pub. No.: US 2015/0242782 A1
(43) Pub. Date: Aug. 27, 2015

(54) Interactive Planning Method And Tool

(71) Applicant: Information Rules OK Ltd, London (GB)

(72) Inventor: Daniel Onions, London (GB)

(73) Assignee: Information Rules OK Ltd., London (GB)

(21) Appl. No.: 14/629,225

(22) Filed: Feb. 23, 2015

(30) Foreign Application Priority Data
Feb. 21, 2014 (GB) GB1403049.8

(51) Int. Cl. G06Q 10/06

(52) U.S. Cl. CPC G06Q 10/06313

(57) ABSTRACT

A method for automated planning of a project is disclosed employing a project planning tool. The project planning tool displays a current plan to a user. The current plan automatically adjusts in light of received progress reports. The project planning tool recognizes and automatically adjusts manpower and time resources in response to initial conditions and later received reports. Time milestones indicating predetermined completion levels are adjusted along a project timeline in response to receive reports. The project planning tool calculates whether or not the project can be completed within the parameters provided and provide corrective suggestions to the user.

### 1. FIELD OF THE INVENTION

The present invention relates to a system and method for planning a project. More particularly it relates to automatic correction of planning resources and milestones during the progress of a project. Most particularly the invention relates to a computer-implemented method for planning, organizing and tracking the progress of a project or team, suited to the management of knowledge-based work.

### 2. PRIOR ART

The act of project planning is well-known throughout history where tasks and timelines are allocated to teams and individuals. Military projects have particularly been subject to detailed planning. During World War II construction of ships, aircraft and other military vehicles was subject to detailed planning, as was their distribution.

Prior planning was employed using charts. A primary chart would be created with resources and timelines allocated. Meetings would be held from time to time to evaluate progress. The primary chart would be progressively modified and resources and timelines adjusted in response to actual progress.

In prior planning, excessive time could be occupied in meetings. Every hour in a meeting is an hour absent from execution of the project. The present invention seeks to reduce the amount of time that individuals spend in attending meetings.

An example of an earlier chart based planning system was the so-called “critical path analysis” system where the critical path was designated to be the single path that would take the most time. Other tasks, related to the project, were given resources and timelines to fit in with the critical path so that, at least as initially planned, the critical path would be the last or co-incidentally last item to be completed.

Use of network and Internet services have meant that planning and progress charts can be made available to a whole host of people who may be connected with a project.

Latterly, project management software has introduced itself to the planning process. Project management software assists project managers in developing plans, describing and assigning resources and tracking progress.

Tasks are common in project planning and task management software applications as a representation of activity that needs to be completed by the user. In project management software tasks are often organised into sub-tasks whereby the attributes of the primary task are automatically calculated based on the information from the subtask, often called a task breakdown structure.

In a project planning software application tasks can be linked together using dependencies in order to produce a schedule—often in the form of a Gantt or Pert chart.

Tracking of project progress is achieved through setting the percentage completion against the tasks on the schedule.

Project management software applications are designed to be generally applicable to a wide variety of projects types, such as construction, events management and software engineering.

Traditional project scheduling software has been successfully used on projects where the tasks have physical dependencies (such as the order of tasks in construction of a new building), however, this type of software is not well suited to knowledge-based work which involves dealing with information, communicating with people and making decisions. Knowledge-based projects often do not have the hard dependencies that task-based schedules often represent, which means that they often represent a misleading view of the way work is really carried out. The use of traditional project scheduling software therefore leads to a number of problems when applied to knowledge based projects.

Tasks stated in the schedules are often approximations of the actual tasks that will actually need to be carried out—since with knowledge-based work there are many micro tasks and decisions that are made.

When the user is planning the project it can be difficult to predict the tasks and the duration of the tasks that are needed, and the most appropriate order of tasks.

The present invention seeks to provide a system and method employing software suitable for use in knowledge-based projects and work.

The dependencies represented in task-based schedules often put artificial constraints on the project since there can very often be a much greater degree of parallel activity than the schedule implies.

The approximation of tasks means that project schedules vary significantly between projects, even for practitioners that purport to be using the same methodology—this makes reuse of estimates and schedules between projects very difficult.

A schedule of tasks that is created at the start of the project often needs to be updated when the project gets underway, since the reality of the project has changed the tasks that need to be performed or the order or duration of the tasks.

Tracking progress against a activity-based plan has a number of problems:

One of the problems with having to recreate the schedule is that project progress tracking is against a changing baseline, which results in reduced control over the project or at least the perception of such from project stakeholders.

Activities within a schedule are often not easily mapped to the outputs that need to be produced.

Project team members can find it difficult to report progress against high level tasks because they do not reflect what they are doing on the project. It is common to have over-optimistic reporting of progress since task progress is not easily verified against the expected output—which means that the last 20% of the task can seem to take the majority of the time—such that tasks that appear to have been on-track are reported based on where they are in the timeline rather than how much work has been completed against the desired outputs of the task.

Tracking against a low level task tends to be a more accurate collection of information, but a schedule of low level tasks is more unstable and more overhead to manage.

In agile project management used in the software industry the project is managed through close collaboration and commitment from the project team to complete a discrete subset of project tasks within a set time period, often named a sprint. Agile project management software typically describes the features that needs to be delivered by the team; at the beginning of each sprint the team commits to which features they will deliver by the end of the sprint. Agile project management allows the scope and focus of a project to be adapted as the project progresses, through regular collaboration with the project stakeholders. One of the problems with agile project management is that there is a perceived lack of control over the scope and timescales of the project. Traditional project schedules can be used in conjunction with agile management methods to plan the high level tasks that will take place during each sprint, but this suffers similar problems as with traditional projects.

Product based planning is a method described in the PRINCE2 project management methodology, for identifying all the work products of a project and the hierarchical relationships between them in the form of a product breakdown structure (PBS). The PBS is used to help create a traditional activity based plan such that the important dependencies are not missed.

Earned value management (EVM) is a technique for measuring project progress and performance. It uses earning rules to quantitatively measure the earned value against (EV) the planned value (PV) and the actual cost (AC). The variance of between these values over the course of the project help to understand the performance of the project to timelines and to budget. Traditional earned value management techniques are dependent on a stable project schedule so that the planned value can be calculated, so given that knowledge-based projects often do not have a stable schedule this can cause a significant problem.

EVM is used as part of agile project management in the software industry. In agile project management for software each sprint is planned to complete a number of user stories (i.e. features or requirements), each of which is estimated using story points as a unit of measure. The earned value is tracked through the completion of story points, which is used to normalise the estimates. The project performance is monitored across sprints often by using a burn-down chart that shows the completed story points against the budget.

Agile project management in the software industry typically only uses one unit of measure (story points) which provides a simple measure, but limits its use in projects that generate different types of content.

Another planning and control method involves so-called “content management”. The output of a knowledge-based project is normally information captured in the form of a document, software artefact or a model of linked information artefacts.

Digital content can be stored on a file system or can managed using content management or electronic document and records management system software (EDRMS). Content management and EDRMS software allows users to store and manage meta-data associated with a stored artefact—which is provided by structured fields to categorise or describe the artefact. In the software industry development artefacts are often captured and maintained in modelling tools, which enables structured content to be managed. A meta-model is often created that shows the significant building blocks of content that is require to be specified, produced or delivered—a meta model will describe the attributes of the content and the relationship between different content types. A meta-model can be used by the modelling repository software to constrain the structure of content that can be put into the repository to enforce standardisation. A meta-model would typically be represented as an Entity Relationship Diagram or Class Diagram (as defined in the Unified Modelling Language (UML)).

Generally in project scheduling, the allocation of resources between different tasks to optimise completion of the project, such as the technique of resource levelling, is a complex, NP-hard problem for which no optimal algorithm is known, and for which computation is expensive so will not scale to large projects with many resources.

### SUMMARY OF THE INVENTION

In one aspect, a computer implemented system for performing resource optimisation in a computationally efficient, scalable, manner may include

a memory; and

one or more processors coupled to the memory, wherein the memory comprises program instructions executable by the one or more processors:

based at least in part, on receiving, from a user, expected work product data;

extracting or calculating content elements from the work product data

using the expected work product data to automatically calculate resource disposition data for execution of the project;

a step of receiving one or more progress reports;

a step of automatically calculating the maturity states for each of a plurality of content elements within the work product data from the progress reports;

a step of automatically capturing from the user indication of the degree to which parallel activity can be allowed to take place between outputs;

a step of automatically calculating the effort required to mature the content of each work product data to each maturity milestones based upon the percentage part of the overall estimate of the element of content;

a step of automatically calculating the aggregate work effort required to mature each work product data and content elements within the estimated time limits; and

a step of automatically calculating the aggregate work effort required by individually skilled resource individuals within the time period place on the wrist skill required by the content element in work product data.

In another aspect a computer implemented system for performing resource optimisation in a computationally efficient, scable, manner may include

a memory; and

one or more processors coupled to the memory, wherein the memory comprises program instructions executable by the one or more processors:

based at least in part, on receiving, from a user, expected work product data;

using the expected work product data to automatically calculate resource disposition data for execution of the project;

a step of automatically allocating resources in response to the calculated resource disposition data and thereby generating a project plan;

a step of receiving one or more progress reports;

extracting further expected work product data, completed work product data and/or resource disposition data from the progress reports

using this extracted data to automatically re-calculating resource disposition data for execution of the project; and

a step of automatically re-allocating resources in response to the re-calculated resource disposition data, and automatically adjusting the project plan in response.

In a further aspect, a project planning tool may include an input means;

a graphical user interface;

a memory; and

one or more processors coupled to the memory, wherein the memory comprises program instructions executable by the one or more processors: based at least in part, on receiving, from a user, expected work product data;

using the expected work product data to automatically calculate resource disposition data for execution of the project; a step of automatically allocating resources in response to the calculated resource disposition data and thereby generating a project plan;

displaying a project timeline axis;

generating categories of deliverables from the expected work product data;

generating and displaying attainment level indicators along the project timeline axis, these attainment level indicators being split or identified in their categories, and aligning the attainment level indicators with the the project timeline axis according to the attainment level.

In yet another aspect a computer implemented system for collaboratively planning and monitoring a project over a network may include

a first user client computer;

at least one contributor client computer;

a project planning tool including a memory; and one or more processors coupled to the memory, wherein the memory comprises program instructions excutable by the one or more processors:

a network;

based at least in part, on the project planning tool receiving, from a user, expected work product data;

the project planning tool using the expected work product data to automatically calculate resource disposition data for execution of the project;

the project planning tool automatically allocating resources in response to the calculated resource disposition data and thereby generating a project plan;

the project planning tool receiving one or more progress reports from the at least one contributor client computer

extracting further expected work product data, completed work product data and/or resource disposition data from the progress reports

using this extracted data to automatically re-calculating resource disposition data for execution of the project; and

a step of automatically re-allocating resources in response to the re-calculated resource disposition data, and automatically adjusting the project plan in response.

These as well as other aspects, advantages, and alternatives, will become apparent to those of ordinary skill in the art by reading the following detailed description, with reference where appropriate to the accompanying drawings.

### BRIEF DESCRIPTION OF THE DRAWINGS

The invention is described in greater detail by the following description to be read in conjunction with the appended drawings: in which:

FIG. 1 is an exemplary block diagram illustrating one environment within which it is possible to use the present invention.

FIG. 2 is an exemplary diagram illustrating in further detail how the system of FIG. 1 can be implemented.

FIG. 3 is an exemplary flow chart illustrating one way in which the operation of the project planning tool of FIG. 1 can be achieved.

FIG. 4 shows an exemplary first screen of a graphical user interface that can be used with the present invention.

FIG. 5 shows an exemplary project plan screen of the graphical user interface which can be used with the present invention.

FIG. 6 show an exemplary project whole screen that can be used in the graphical user interface provided to the user within the present invention.

### DETAILED DESCRIPTION

The invention is now described here below as a series of examples, those skilled in the art of being aware of many variations and modifications that can be applied without deviating from the spirit of the invention.

Resource leveling is a hard problem because of the way it is constrained by activity dependencies which require exact allocations in any given time period. By optimising based on the effort required to create an output and to reach output maturity milestones, computer systems disclosed herein reduce the computational effort required to optimise the allocation of resources. The use of such approximation algorithm turns out to be well suited to allocation of resources to projects. They are also scable, allowing complex projects, or multiple projects sharing resources to be managed more efficiently, and be used on devices with limited computational power

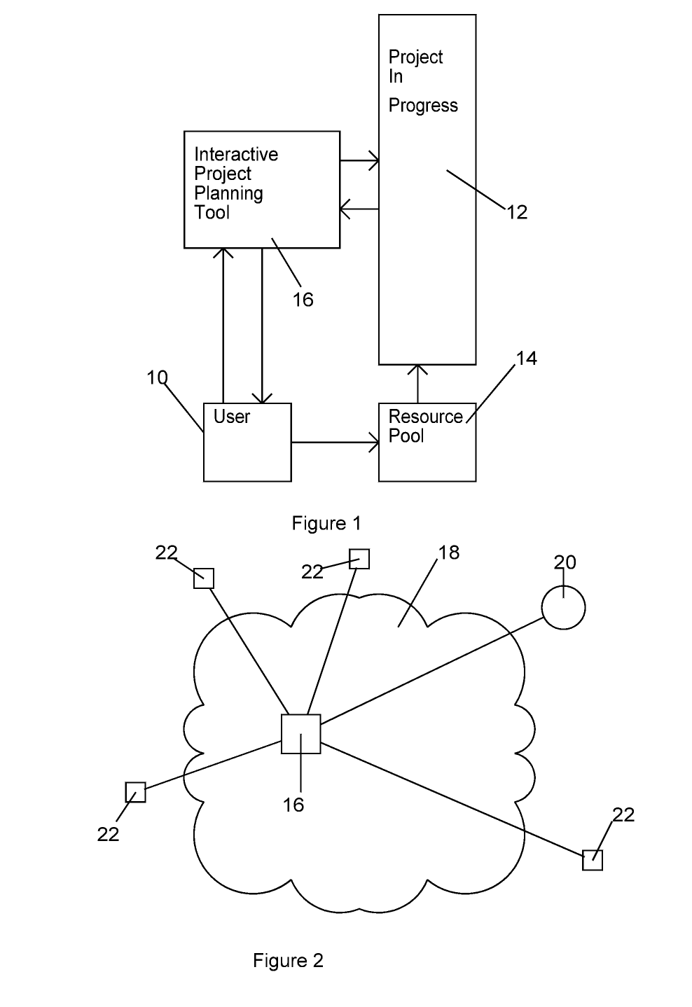

Attention is first drawn to FIG. 1, an exemplary block diagram illustrating one environment within which it is possible to use the present invention.

A user 10 initiates the preparation of a project 12 to be executed using a resource pool 14 under scrutiny of an automatic project planning tool 16 that receives input from the user 10, provides output to the user 10, and co-operates with the project 12 as it evolves. The resource pool 14 may serve a number of in-progress projects with potentially competing resources. The project planning tool 16 will assist making decisions between projects based on the resources available and currently committed. Options selected may, for example, be to move resources between projects.

The project planning tool 16 comprises one or more processors. The project 12 involves, in this example, preparation of documents and computer code reflecting a program or set of programs it is desired to prepare. It is to be understood that the present invention relates to preparation of many different kinds of project, the type and nature of which will become apparent to those skilled in project management.

The user 10 initiates the process by allocating the content of the resource pool 14 and communicating the content of the resource pool 14 to the project planning tool 16.

The resource pool, in the example here shown, can comprise, but is not limited to:

1. Various sub targets required for completion of the task and the times anticipated for the completion of each sub target.

2. Operators, such as managers and specialists, their numbers and allocated sub targets, and allocated work hours.

3. The connection between each sub target and the greater project. This can involve inclusion of sub targeted items within other sub target items.

The project planning tool 16, having received the resource pool 16 content, then calculates whether or not the project can be executed within the time limits and using the individuals listed. If the project can be executed within the parameters specified, the project planning tool 16 informs the user 10. If the project planning tool 16 calculates that the project cannot be executed within the parameters, the project planning tool 16 informs the user 10 and offers various options whereby the project 12 can be achieved. It may be, of course, that the project 12 cannot be achieved, in which case the project planning tool 16 so informs the user 10. The user 10, selects one of the options offered by the project planning tool 16, and the project 12 can then proceed.

From time to time the state of the project 12 is updated. This can relate to one, some or all of the sub targets. Equally, operators can become absent from or can be added to the resource pool 14. The project planning tool accepts the updated information, re-calculates whether or not the project can still be achieved, and either indicates to the user 10 that the project is on the way to be achieved, or indicates that the project can no longer be achieved and provides further options to the user 10 for selection.

The user 10, in response to the indications from the project planning tool 16, adjusts the content and allocation of resources in the resource pool 14. At each adjustment, the project planning tool 16 re-checks whether or not the project 12 can be achieved.

The project planning tool 16 thereby causes the project planning process to become dynamic and interactive. The planning of the project automatically is guided and adjusted according to what actually occurs within project execution.

It is to be appreciated that though FIG. 1 show a single project 12 having a single resource pool 14 and a project planning tool 16, serviced by a single user 10, a single project planning tool 16 can simultaneously be employed on two or more projects 12 having one or more resource pools 14. A resource manger user can also communicate with the project planning tool 16 and the one or more resource pools 14.

Attention is next drawn to FIG. 2, an exemplary diagram illustrating in further detail how the system of FIG. 1 can be implemented.

The project planning tool 16, in this example, exists within a network 18 that can be a self-contained large or wide area network, or can even be the Internet. A user client 20 provides interconnection of the user 10 with the project planning tool 16. Contribution clients 22 can coupled to the project planning tool 16 to provide indication of the input. The contribution clients 22 can be sites where ongoing progress of the sub elements of the sub targets are in the course of preparation. Equally, the contribution clients 22 can be mere monitoring clients watching the result of the ongoing project 12. Not shown in FIG. 2 are any connections between other clients and the user client 20, such as those employed for overview of the project, which, as will become clear, do not actually become involved in the operation of the present invention.

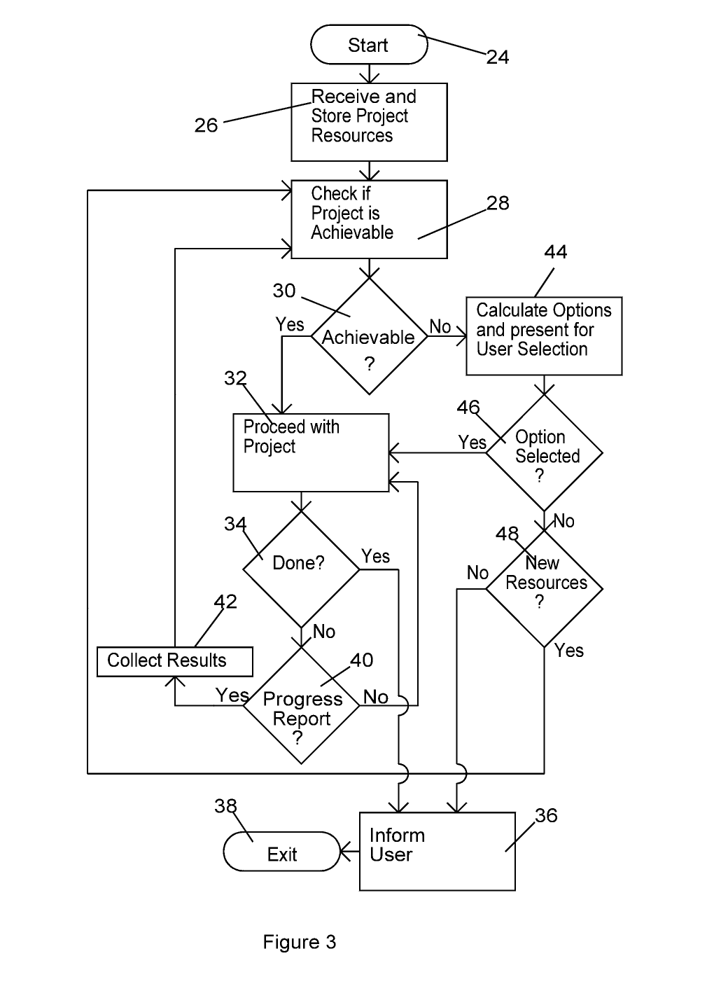

Attention is next drawn to FIG. 3, an exemplary flow chart illustrating one way in which the operation of the project planning tool 16 can be achieved.

From a start 24 a first operation 26 receives and stores the content of the resource pool 14 proposed by the user 10 to achieve the project 12 within the parameters specified in the resource pool 14.

A second operation 28 then checks to see if completion of the project 12 is possible within the parameters provided in the resource pool 14.

If a first test 30 finds that the project 12 is achievable within the parameters in the resource pool 14, a third operation 32 indicates to the user 10 that the project 12 is achievable within the parameters provided in the resource pool 14 and the user responds by arranging for the project 12 to proceed with the current resource pool 14 entries.

If a second test 34 detects that the preparation of the project has been completed, a fourth operation 36 informs the user 10 that the project 12 is completed and passes control to an exit 38.

If the second test 34 does not find that the project 12 is complete, a third test 40 checks to see whether or not a progress report is available. If the progress report is available, a fifth operation 42 collects and applies the up dated results from the progress report and submits the new updated results to the second operation 28 to see whether or not the project 12 can be achieved.

If the first test 30 finds that the project 12 is not achievable within the parameters, a sixth operation 44 calculates the options available for completion of the project either within or outside of the parameters. The sixth operation 44 presents a range of options to the user 10. The user 10 can then select an option. If a fourth test 46 finds that the user 10 has selected an option, control is passed to the third operation 32 which proceeds with the project as currently configured by the resource pool 14.

If the fourth test 46 finds that the user 10 will not pick an option, control is passed to a fifth test 48 which checks to see if the user 10 has chosen to provide new resources into the resource pool 14. If the user 10 has chosen to provide new resources, the fifth test 48 passes control back to the second operation 28 to determine whether or not the project 12 is achievable given the current state of the parameters within the resource pool 14.

In the situation where there are other projects that are resourced from a wider pool 14, the project planning tool 16 presents options for reallocating resources from other projects. The resource manager decides whether new resources can be reallocated, a shown in FIG. 1.

If the user 10 has not provided any new resources into the resource pool 14, the fifth test 48 passes control to the fourth operation 36 which indicates to the user 10 that the project planning tool 16 considers that the project 12 preparation cannot be achieved by virtue of lack of option selection and lack of provision of new resources. As before the fourth operation 36 then passes control to exit 38.

The user 10, having exited the project planning tool 16, has the option of returning to the project planning tool 16 at a later time, using the stored resources in the resource pool 14 as they have been updated, and either providing further resources or selecting options as they are presented.

Options provided to the user 10 by the sixth operation 44 can include, but are not limited to: extension of dates for completion and percentage completion milestones along each sub-element timeline; extension of dates for completion of the overall project; addition of personnel working on the project; removal of personnel from the project; movement of personnel within the project; re-allocation of personnel hours working on the project; re-allocation and definition of sub elements within the project; and change of cost estimates.

The resource pool remains unchanged until change is made. Thereafter, the changed and updated resource pool 14 is used for all future calculations within the sixth operation 44.

When assessing the progress of completion of a sub element, the initially provided resource such as human operators and associated equipment acts as a starting point, and rate of progress is assessed and adjusted according to the results achieved in that sub element.

Each physical resource and human resource present in the resource pool 14, whether as initially cast by the user 10 or as modified during the progress of the project 12, bears a monetary cost. It is another object of the invention that the project planning tool 16 provides the ability to cost the project and sub elements to provide the user 10 with financial information.

The second test 34 can assess whether or not the project 12 has come to a completion by various means.

A first means involves the project having reached its expected completion date and time.

A second means involves receipt by the project planning tool 16 from a contributor client that the last element or sub element for the overall project is now complete.

The activities shown in FIG. 3 allow a constantly interactive project planning tool to provide for adjustment to a plan in light of actual progress in execution of the project 12. As the project 12 progresses, a truer picture of the progress and expected progress is constructed allowing better prediction and prognostication.

While the assessment made by the sixth operation 44 and the second operation 28 based on the initial content of the resource pool 14 given by the user, if the project 12 is the first to be executed, are essentially based on user 10 guesses and presumptions, if the project planning tool 16 is not being used by the user for a first time, assessments can be made by the sixth operation 44 and the second operation 28 based on previous results and measurements of performance. A user 10 profile can then be built up giving the project planning tool 16 a much better opportunity realistically to assess project execution times based on as many times the user 10 has employed the project planning tool 16. To this end, it is preferred that the user 10 can be identified as an individual or an identifiable team so that the user 10 profile can be applied.

The flowchart of FIG. 3 is only exemplary of one way in which the function of the project planning tool 16 can be achieved. Those skilled in the art will perceive many different configurations and variations that can be achieved without diverging from the invention as claimed.

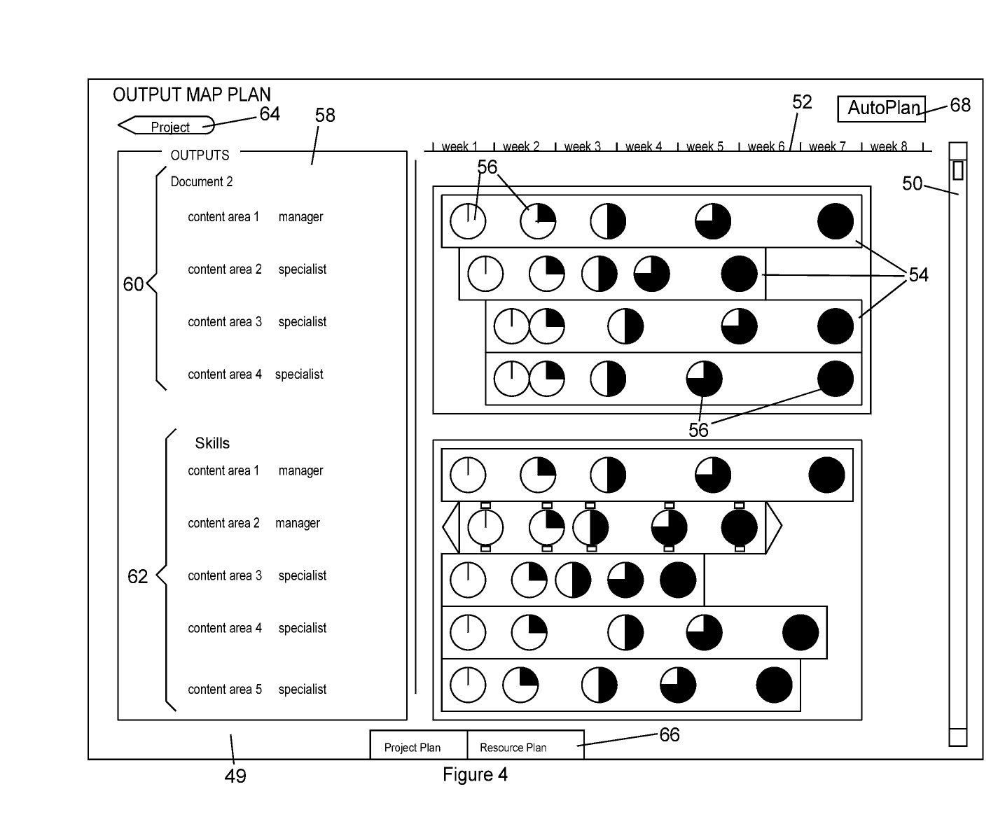

In use, the project planning tool 16 preferably employs a graphical user interface for interaction with the user 10. FIG. 4 shows an exemplary first screen of a graphical user interface that can be used with the present invention.

As earlier stated, the example here shown of the invention is employed for creation of documents and of sub elements of code sequences intended to facilitate creation of an overall program. It is to be appreciated that other applications for the invention of possible including, but not limited to, construction of all kinds, manufacturing of all kinds; website creation; and publishing.

In FIG. 4, an exemplary output map plan screen 49 is shown on the graphical user interface which can be employed to provide co-operative interaction of the project planning tool 16 with the user 10. The

In FIG. 4 a scroll bar 50 permits viewing of higher and lower portion of the content of the screen by movement of a pointer applied thereto. In touchscreen variants a simple movement of an applied scribing tool or human digit can achieve the same purpose.

A project timeline 52 is provided across the portion of the top of the sheet shown, designating the duration of the project 12. While in this instance a duration span of eight weeks is shown, it is to be appreciated that the project timeline 52 can be as long or as short as is required by the duration of the project.

Horizontal partitions 54 each contain five attainment level indicators 56. Each of the horizontal partitions 54 represents a sub element of required attainment within the project 12. The attainment level indicators are marked according to the degree of expected attainment, in this instance employing a pie chart positioned along the project timeline 52 at those positions where they were either achieved or are expected to be achieved. The attainment level indicators 56 are placed progressively long each horizontal partition 54 starting with zero attainment and ending with 100% attainment. It is to be appreciated that the attainment indicators can represent any number of levels, not just in 25% increments. The attainment levels may be labelled with qualitative maturity descriptions and with other quantitative levels apart from percentages.

Reported results for the project involve movement of the attainment level indicators 56 along the project timeline to those positions where that percentage of attainment actually occurred.

While in the present example the attainment level indicators 56 are shown as a pie chart divided into quarters, it is to be appreciated that any other form of attainment indication can be used, including, but not limited to, use of a percentage achievement number within each attainment level indicator 56.

A deliverables/output list 58 is provided to one side of the vertically arrayed horizontal partitions 54. In the example shown, outputs are listed with the skill required to produce each output from the projects 12 are listed. A first list 60 shows a document within the elements of content, listing the skill required for each element. A second list 62 shows an output and the elements of the output required to produce the output. Each list also shows the current assignment of managers, specialists and other active human participants.

A horizontal partition 54 is provided beside each output element to show expected attainments (maturity level) and the expected or achieved dates.

Also provided on the graphical user interface screen shown in FIG. 4 are various buttons which, when clicked or activated move the screen displayed to be another the screen. A project home button 64 causes this screen shown in FIG. 4 to change to the project home screen, described hereafter. Screen selection buttons 66 allow either the screen shown in FIG. 4 to be selected or the resource plan screen, shown hereafter.

An AutoPlan button 68 allows the project planning tool 16 to reassess the positions of the projected attainment level indicators and, to assess whether or not the project is achievable within the parameters shown on the graphical user interface screens.

Although in FIG. 4 such terms as “content area 1”, “content area 2” etc are used in FIG. 4, it is to be appreciated that the user can apply more meaningful names there to. Although such skill levels are described in FIG. 4 as “manager” and “specialist” are shown, it is also the to be appreciated that the user 10 can apply more descriptive and realistic names there to.

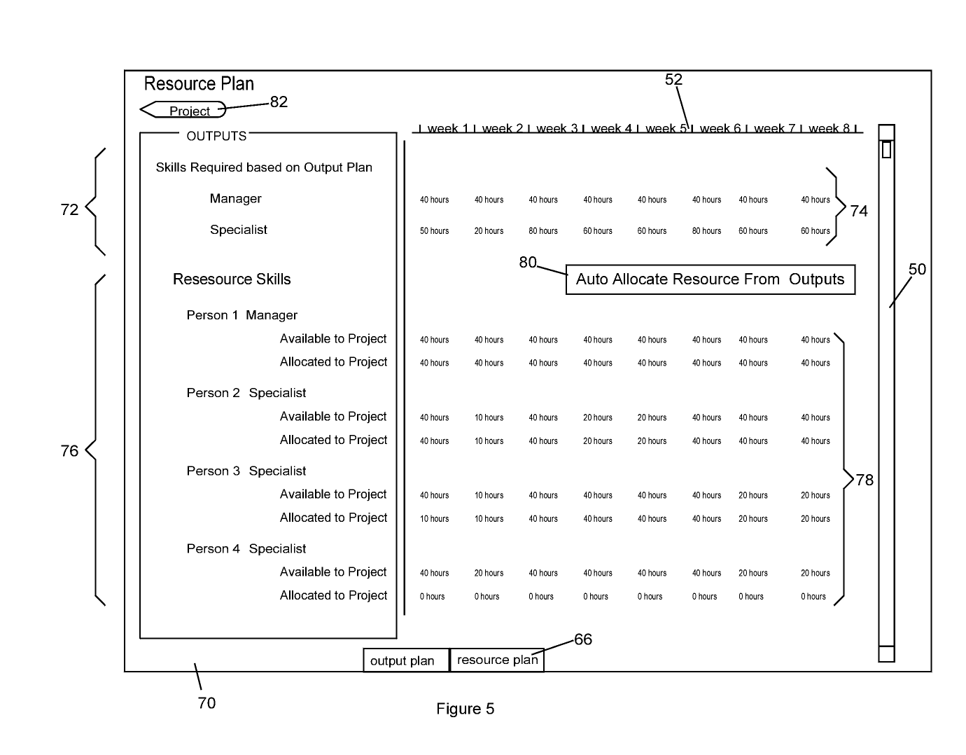

Attention is next drawn to FIG. 5, showing an exemplary resource plan screen 70 of the graphical user interface which can be used with the present invention.

In, and with the previously shown project plan screen 49 in FIG. 4, the project timeline 52 and the screen selection buttons 66 are also provided. Their function is already described in the description given for FIG. 4, and does not require to be elaborated upon for FIG. 5.

FIG. 5 lists the type and time of availability and actual allocation for various types of staff.

A weekly skill requirements list 72 lists the skills required each week to achieve the output plan. In an hours requirement portion 74 the number of hours required by each skill type is listed.

It is to be understood that, although this shows a weekly allocation, the time periods could show totals of any other time period, including hourly, daily, weekly, monthly and yearly.

In individual resource names and skills list 76 lists by name and skill each of the individuals involved with the project 12. Although names like “individual 1, individual 2 etc are used in the drawing, it is to be understood that the user 10 will supply actual names or other identifiers. It is to be understood that although in the figure such names as “manager” and “specialist” are used, the user 10 will supply more accurate descriptions if required.

A weekly availability and time allocation list 78 lists the time, by each week, that a named individual will be available if required and also lists the actual time allocated to each individual for execution of the project 12.

The individual resources 76 are prioritised such that those already allocated to the project 16 and those with the most suitable skills and availability are shown at the top of the list. This also shows individuals within the resource pool 14 assigned to other projects that may also be suitable and could be used if this is a higher priority project.

An auto allocation button 80 can be activated by the user 10 to cause the allocation of resources to be updated in light of the latest reported outputs and displayed on the resource plan screen 70.

A project button 82 can be activated by the user 10 to move to the project screen, described hereafter.

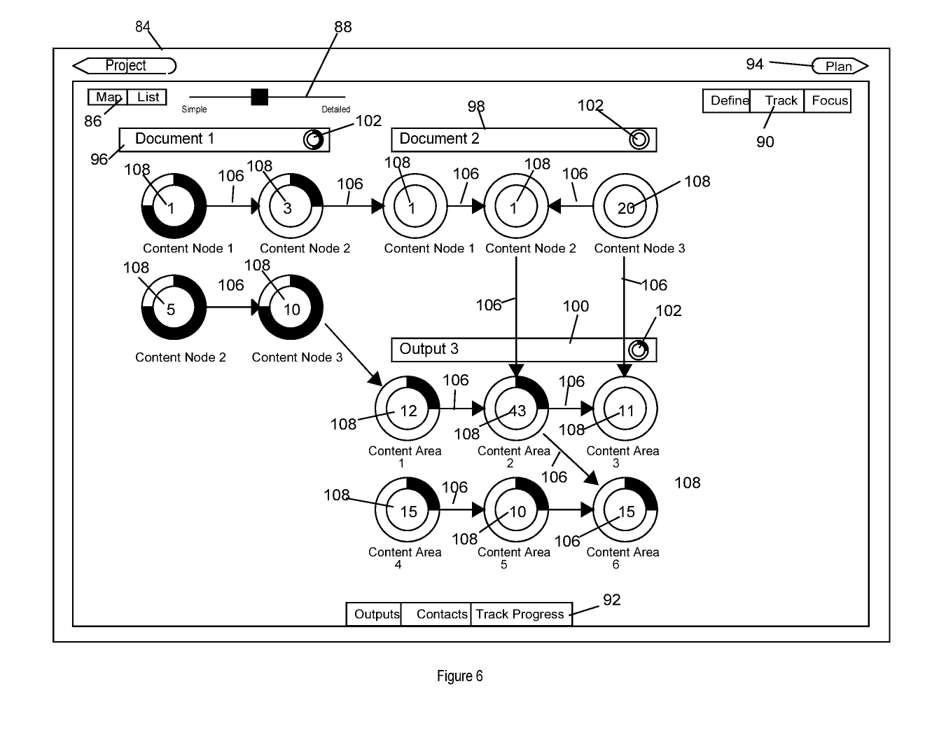

Attention is finally drawn to FIG. 6 showing an exemplary project whole screen 84 that can be used in the graphical user interface provided to the user 10 within the present invention.

A map/list button 86 allows the user 10 to elect the project home screen 84 to show either alphanumeric lists or maps. In the example shown, a map is selected.

A detail slider 88 can be adjusted by the user 10 to determine the degree of detail shown in the project home screen 84.

Operational buttons 90 permit the user 10, in the example shown, to elect whether an action or entry is a definition, or is to be tracked, or is to be focused upon.

Selection buttons 92 allow the user to select what is to be displayed, in the example shown the selection being offered between outputs, contacts and tracking of progress.

A return to plan screens button 94 allows the user 10 to elect to return to a selectable one of the resource plan screen 49 and the resource plan screen 70.

Various headers are provided within the project home screen 84. A first document title 96, a second document title 98 and an output title 100 are shown in this example. It is to be understood that the user will provide more meaningful titles than those given when the project planning tool 16 is set up.

At the end of each title is provided a miniaturised of completion roundel 102 that shows, at a glance the stepwise completion state of each titled item, by means of filled quadrants, in a similar manner to the filled quadrants shown in FIG. 4. The miniaturised roundels 102 summarise the level of completion from the output elements within.

Beneath each title 96 98 100 are arranged full-size roundels 104 each relating to an area of activity. The roundels are identical in every way to the miniaturised completion roundels 102 and similarly each display the state of completion of their respective area of activity. Each full-size roundel 104 is given a distinguishing title by the user. The user 10 also provides arrows 106 between full-size roundels 104 indicating the relationship between the content represented by each full-size roundel 104.

Node indicating numerals 108 are provided within each full-size roundel to indicate the work effort estimates to complete the output (in days, based on an 8 hour day). This is captured from the user as part of the process of estimating the effort to complete. It is also to be understood that the effort (here shown in days) can be captured in any time unit, and translated to other time units based on reference information.

The user 10, by use of the exemplary graphical user interface screens 49 70 84 can readily see the state of a project and adjust parameters in the resource pool 14. Access to the automatic planning facility within the project planning tool 16 is also provided.

Graphical user interfaces of a similar nature can be provided to user clients 20 whereby they can signal and report progress in their allocated portion of the project 12. It is also preferred that the individual user clients 20 can receive reallocation of resources to enable completion not only of their allocated portion of a project, but also to the greater project 12.

The graphical user interface screens 49 70 84 are provided by way of example only. Those skilled in the art will be aware of many variations and changes that can be made without causing the invention to depart from the following claims.

To summarize, the invention allows for constant tracking and modification of the planning of a project in response to the timing of actual achievements within the project. Those skilled in the art will be aware of many modifications and variations that can be applied without departing from the invention as claimed.

What is claimed:

1. A computer implemented system for performing resource optimisation in a computationally efficient, scalable, manner comprising
a memory; and
one or more processors coupled to the memory, wherein the memory comprises program instructions executable by the one or more processors:
based at least in part, on receiving, from a user, expected work product data;
extracting or calculating content elements from the work product data
using the expected work product data to automatically calculate resource disposition data for execution of the project;
a step of receiving one or more progress reports;
a step of automatically calculating the maturity states for each of a plurality of content elements within the work product data from the progress reports;
a step of automatically capturing from the user indication of the degree to which parallel activity can be allowed to take place between outputs;
a step of automatically calculating the effort required to mature the content of each work product data to each maturity milestones based upon the percentage part of the overall estimate of the element of content;
a step of automatically calculating the aggregate work effort required to mature each work product data and content elements within the estimated time limits; and
a step of automatically calculating the aggregate work effort required by individually skilled resource individuals within the time period place on the wrist skill required by the content element in work product data.

2. The system according to claim 1 wherein the information received from the user comprises at least one of:
expected works products and content elements within each work product; skill levels required to create each of the content elements; estimation of the effort required to complete each work product and the elements of content in each work product within the time available; and dependency relationships between content elements within the project deliverable items.

3. The system according to claim 1 wherein the step of automatically calculating the maturity states of each of the content elements include the steps of:
a step of automatically allocating dependency between content elements and spreading the proposed work across a timeline in dependency order of outputs; and
a step of allowing a level of overlap in proposed content production.

4. The system according to claim 2 wherein the step of automatically calculating the maturity states of each of the content elements include the steps of:
a step of automatically allocating dependency between content elements and spreading the proposed work across a timeline in dependency order of outputs; and
a step of allowing a level of overlap in proposed content production.

5. The system according to claim 1 wherein the step of automatically showing the degree to which parallel activity can be allowed to take place between outputs includes the steps of automatically adjusting the plan by automatic adjustment of maturity milestones based on the available amount of team resources.

6. The system according to claim 1 wherein the step of automatically showing the degree to which parallel activity can be allowed to take place between outputs includes the steps of automatically adjusting the plan by automatic adjustment of maturity milestones based on the available amount of team resources.

7. The system according to claim 1 wherein the step of automatically showing the degree to which parallel activity can be allowed to take place between outputs includes the steps of automatically adjusting the plan by automatic adjustment of maturity milestones based on the available amount of team resources.

8. The system according to claim 2 wherein the step of automatically showing the degree to which parallel activity can be allowed to take place between outputs includes the steps of automatically adjusting the plan by automatic adjustment of maturity milestones based on the available amount of team resources.

9. The system according to claim 3 wherein the step of automatically showing the degree to which parallel activity can be allowed to take place between outputs includes the steps of automatically adjusting the plan by automatic adjustment of maturity milestones based on the available amount of team resources.

10. The system according to claim 1 wherein there is included a first user client computer
at least one contributor client computer;
a network;
the expected work product data being received from the first user client computer;
the one or more progress reports being received from the at least one contributor client computer.

11. A computer implemented system for performing resource optimisation in a computationally efficient, scalable, manner comprising:
a memory; and
one or more processors coupled to the memory, wherein the memory comprises program instructions executable by the one or more processors:
based at least in part, on receiving, from a user, expected work product data;
using the expected work product data to automatically calculate resource disposition data for execution of the project;
a step of automatically allocating resources in response to the calculated resource disposition data and thereby generating a project plan;
a step of receiving one or more progress reports;
extracting further expected work product data, completed work product data and/or resource disposition data from the progress reports
using this extracted data to automatically re-calculating resource disposition data for execution of the project; and
a step of automatically re-allocating resources in response to the re-calculated resource disposition data, and automatically adjusting the project plan in response.

12. The system of claim 11 wherein the details comprise at least one of:
the expected content within each work product; the skill required to create each of the content elements; the preferred time period where work will be performed on each of the work product; estimates of effort to complete for each work products and elements of content; dependency relationship between content elements; and the expected maturity states of each content element across time.

13. The system according to claim 11 wherein the step of calculating resource disposition includes:
a step of calculating the aggregate work effort required to mature each work product and content elements within the allocated time period;
a step of calculating the aggregate work effort required by individuals to achieve the content element in the work product by the allocated time period; and
a step of automatically calculating the resources for the project based on optimising the fewest resources within the time of the project by allocating resources that meet the aggregate skill required.

14. The system according to claim 12 wherein the step of calculating resource disposition includes:
a step of calculating the aggregate work effort required to mature each work product and content elements within the allocated time period;
a step of calculating the aggregate work effort required by individuals to achieve the content element in the work product by the allocated time period; and
a step of automatically calculating the resources for the project based on optimising the fewest resources within the time of the project by allocating resources that meet the aggregate skill required.

15. The system according to claim 10 wherein there is included a first user client computer
at least one contributor client computer;
a network;
the expected work product data being received from the first user client computer;
the one or more progress reports being received from the at least one contributor client computer.

16. The system according to any of claim 10 wherein the step of automatically adjusting the project plan includes a step of automatic flattening of resource effort required to allow fewer individual resources individuals to work by automatically adjusting maturity milestones to increase or reduce the demand for work of a given skill level.

17. The system of claim 16 wherein the step of automatically flattening the level of resource skills includes the steps of:
a step of automatically selecting resources that meet skill levels required throughout the life of the project;
a step of automatically determining ideal project start and end times based on what resources are available;
a step of indicating to the user when an increase in resource availability would optimise use of other resources.

18. A project planning tool comprising a
an input means;
a graphical user interface;
a memory; and
one or more processors coupled to the memory, wherein the memory comprises program instructions executable by the one or more processors:
based at least in part, on receiving, from a user, expected work product data;
using the expected work product data to automatically calculate resource disposition data for execution of the project;
a step of automatically allocating resources in response to the calculated resource disposition data and thereby generating a project plan;
displaying a project timeline axis
generating categories of deliverables from the expected work product data
generating and displaying attainment level indicators along the project timeline axis, these attainment level indicators being split or identified in their categories, and aligning the attainment level indicators with the project timeline axis according to the attainment level.

19. A project planning tool according to claim 18 including a step of receiving one or more progress reports;
extracting further expected work product data, completed work product data and/or resource disposition data from the progress reports
using this extracted data to automatically re-calculating resource disposition data for execution of the project; and
generating and displaying updated attainment level indicators along the project timeline axis, these attainment level indicators being split or identified in their categories, and aligning the attainment level indicators with the project timeline axis according to the attainment level;
automatically reassess the positions of the projected attainment level indicators and/or to assess whether or not the project is achievable within the parameters shown on the graphical user interface screens.

20. A project planning tool according to claim 18 wherein there is included a first user client computer
at least one contributor client computer
a network
the expected work product data being received from the first user client computer;
the one or more progress reports being received from the at least one contributor client computer.
